(19) United States
(12) Patent Application Publication
(10) Pub. No.: US 2024/0132244 A1
(43) Pub. Date: Apr. 25, 2024

(54) LABELING MACHINE

(71) Applicant: P.E. LABELLERS S.P.A., Porto Mantovano (IT)

(72) Inventor: Riccardo BARDINI, Torri del Benaco (IT)

(21) Appl. No.: 18/278,035

(22) PCT Filed: Feb. 18, 2022
(86) PCT No.: PCT/EP2022/054135

§ 371 Date: Aug. 20, 2023

(30) Foreign Application Priority Data
Feb. 23, 2021 (IT) 102021000004100

(51) Int. Cl. B65C 9/22; B65C 3/16

(52) U.S. Cl. CPC B65C 9/226; B65C 3/16

(57) ABSTRACT

A labeling machine, which includes a conveyor for conveying containers to be labeled and at least one labeling station provided with an unwinding assembly for a label ribbon on which a plurality of labels are printed in succession, and at least one drum which is provided, peripherally, with runners which have at least one relief portion, in relief with respect to the lateral surface of the drum; a spreading roller for spreading adhesive on the label ribbon; at least one of the runners has at least one contoured part in order to allow the application, by the spreading roller, on the portion of the label ribbon and/or of the labels that is on the contoured part, of at least one adhesive imprint which has at least one region without adhesive.

The present invention relates to a labeling machine.

Labeling machines are known which make it possible to execute, in an automated manner, the application on containers of labels that are obtained by cutting a continuous label ribbon which is taken from a reel on which a plurality of labels are printed in succession.

Typically, in labeling machines, the containers to be labeled are conveyed, along an advancement path, by conveyance means, which are usually constituted by a rotating carousel, provided with a plurality of supports for the individual containers, which are adapted to make the containers themselves rotate about their own axes.

Along the advancement path of the containers, there is furthermore at least one labeling station which is provided with an unwinding assembly which makes it possible to take the label ribbon from its reel, optionally making it pass through means of adjusting the tension, and to feed it to a cutting drum, which is provided, on its peripheral region, with blades that make it possible to perform the cutting of the label ribbon between one label and the next.

Upon leaving the cutting drum, the individual labels thus cut come into contact with a transfer drum which makes them adhere to the containers, conveyed by the carousel, which are progressively presented before the transfer drum.

In particular, the labels are arranged so that they adhere to the transfer drum at corresponding sectors of the outer lateral surface of the transfer drum.

If the label ribbon has no adhesive preapplied, then the labeling machine is provided with a gluing unit, which can be constituted by an adhesive spreading roller, arranged adjacent to the transfer drum, which applies, at the leading, or front, and trailing, or rear, edges of each label, a layer of glue, before the labels are taken by the transfer drum to adhere to the respective containers conveyed by the carousel.

In particular, if the gluing unit is constituted by a spreading roller, at the ends of the various sectors of the transfer drum there are two adhesive bonding regions, which are in relief with respect to the main lateral surface of the transfer drum and which are defined by respective blocks, called runners, on which the leading and trailing edges of the labels are designed to come to rest, so that when the labels pass in front of the spreading roller, the latter applies a certain amount of glue to those labels which is distributed so as to form only two adhesive imprints or areas in the form of continuous strips, substantially rectangular in shape, which extend transversely to the longitudinal extension of the label ribbon.

So as to generate adhesive imprints of this shape on the leading and trailing edges of the labels, the runners are shaped so as to present a relief portion that is shaped correspondingly with respect to the adhesive imprint that is created, such that this relief portion is substantially constituted by a rib that protrudes radially from the lateral surface of the transfer drum, and which extends, along its longitudinal axis, substantially in parallel to the axis of the transfer drum and which has, on its outermost end, opposite from the end connected to the remaining part of the corresponding runner, a contact surface that is substantially outwardly convex and continuous, against which the side of the label that is to receive the adhesive imprint from the spreading roller comes to rest.

In order to prevent the labels from remaining attached to the spreading roller, they are kept adhered to the lateral surface of the transfer drum and to the runners by virtue of holes connected to air suction means, which are provided both in the lateral surface of the transfer drum and in the runners themselves.

During the operation of the labeling machine, since individual separated labels adhere to the transfer drum, it often happens that the transfer drum can be smeared with glue, which results in the machine having to be shut down in order to carry out the necessary cleaning thereof.

There are also labeling machines, in which the transfer drum comprises cutting devices, distributed around its peripheral region, which make it possible to perform the cutting of the label ribbon at the separation portions between one label and the next and which are capable of retaining, on the lateral surface thereof, the labels provided after cutting in order to cause them to adhere to the corresponding bottle. In this case, the transfer drum is more properly called the “cutting and transfer drum”.

Machines of this type are known, in which the cutting devices are activated in order to perform the cutting of the labels after the application of the glue to those labels by the spreading roller, so as to avoid the possibility of the spreading roller smearing the lateral surface of the transfer drum with glue.

In particular, a labeling machine is known from WO2018/114618, in the name of this same applicant, in which the unwinding assembly feeds the label ribbon directly to the transfer drum, which, in this case, is provided with cutting devices, each one arranged in a position immediately behind a respective runner, in the direction of rotation of the transfer drum, and each one constituted by a respective blade, which is integrally fixed to the transfer drum and is accommodated in a corresponding suction chamber, which is open at the lateral surface of the transfer drum and connected to air suction means, which make it possible to pull the labeling ribbon inward into the chamber and against the blade, so as to result in the cutting thereof.

This labeling machine is further provided with control means that make it possible to vary the feeding speed of the label ribbon to the transfer drum by the unwinding assembly, during the rotation of the transfer drum, so as to determine steps of operation of the machine in which the feeding speed of the label ribbon is the same as or slightly slower than the peripheral speed of the transfer drum, in order to enable the spreading roller to apply a respective adhesive imprint on the leading edge and on the trailing edge of two consecutive labels of the label ribbon, which are placed on a runner that passes in front of a spreading roller, or in order to enable a cutting device to perform the cutting of the label ribbon between two consecutive labels, and steps of operation of the machine in which the feeding speed of the label ribbon to the transfer drum is, instead, slower than the transfer speed of the labels, in order to allow a slippage of the transfer drum with respect to the label ribbon, so as to position the cutting device at the separation portion between two consecutive labels, on which the spreading roller has previously applied the glue, immediately behind the runner on which the trailing and leading edges of these two consecutive labels were placed when the spreading roller applied the glue, or in order to remove the cut label from the rest of the label ribbon, after activating the cutting device that performed the cutting thereof.

There is a widely felt need for the machines described above to be able to limit as far as possible the amount of adhesive transferred to the labels by the spreading roller, so as to obtain a saving in the running costs of the machine.

Another need that is currently widely felt is that of ensuring that the labels applied on the containers can be easily removed from these containers in order to allow these containers to be reused with a new label, after being washed and sterilized, so as to limit the dispersion in the environment of empty containers.

A problematic aspect of the current labeling machines is to be able to apply the labels correctly even on containers that have, on their outer lateral surface, a contouring formed by crests and troughs. In fact, with containers of this type, labels with adhesive imprints applied to their edges that are constituted by continuous rectangular strips of adhesive that extend transversely to the labels tend also to adhere to the troughs present on the external surface of the containers, thus taking on an undulating pattern, which is not appreciated since it makes the label difficult to read.

Furthermore, the glue present in the adhesive imprints at the troughs of the containers is not necessary for fixing the label to the containers, as the glue present at the crests of the containers is sufficient, and therefore this glue is wasted.

In order to seek to overcome these problems, labeling machines have been proposed in which the runners continue to have a relief portion, still with a contact surface for the portion of the label intended to receive the glue that is flat and continuous, but in which the lateral surface of the spreading roller is not smooth, but is contoured with some parts more in relief than others, so as to be able to apply to the labels not adhesive imprints constituted by simple continuous strips of glue, as typically happens in traditional machines, but adhesive imprints comprising not only regions with adhesive but also regions without adhesive, which are designed to facilitate the removal of those labels and/or to be arranged at troughs present on the outer lateral surface of the containers on which the labels are to be applied.

This solution, although valid in resolving the problems described above and in not creating unwanted wrinkling on the labels, has the drawback however of entailing a certain complexity of construction in the provision of the spreading roller.

Furthermore, this solution does not allow the possibility to change the format of the labels, unless the spreading roller is replaced, which however entails considerable operational difficulties and long machine shutdown times.

The aim of the present invention is to provide a labeling machine that is capable of improving the known art in one or more of the above mentioned aspects.

Within this aim, an object of the invention is to provide a labeling machine that makes it possible to apply adhesive imprints to the labels that are appropriate to the format of the labels, without wasting glue.

Another object of the invention is to provide a labeling machine that makes it possible to apply adhesive imprints to the labels that conform to the shape of the containers, without the risk of the labels wrinkling.

Another object of the present invention is to provide a labeling machine that can be rapidly and easily adapted to a change of format of the labels.

Another object of the present invention is to provide a labeling machine that in terms of construction is simple to provide.

Another object of the invention is to provide a labeling machine that is capable of offering wide-ranging guarantees of safety and reliability in operation.

A further object of the present invention is to overcome the drawbacks of the background art in a manner that is alternative to any existing solutions.

Another object of the invention is to provide a labeling machine that can be produced at low cost, so as to be competitive from a purely economic viewpoint as well.

This aim and these and other objects which will become better apparent hereinafter are achieved by a labeling machine according to claim 1, optionally provided with one or more of the characteristics of the dependent claims.

Further characteristics and advantages of the invention will become better apparent from the description of preferred, but not exclusive, embodiments of the labeling machine according to the invention, which are illustrated for the purposes of non-limiting example in the accompanying drawings wherein:

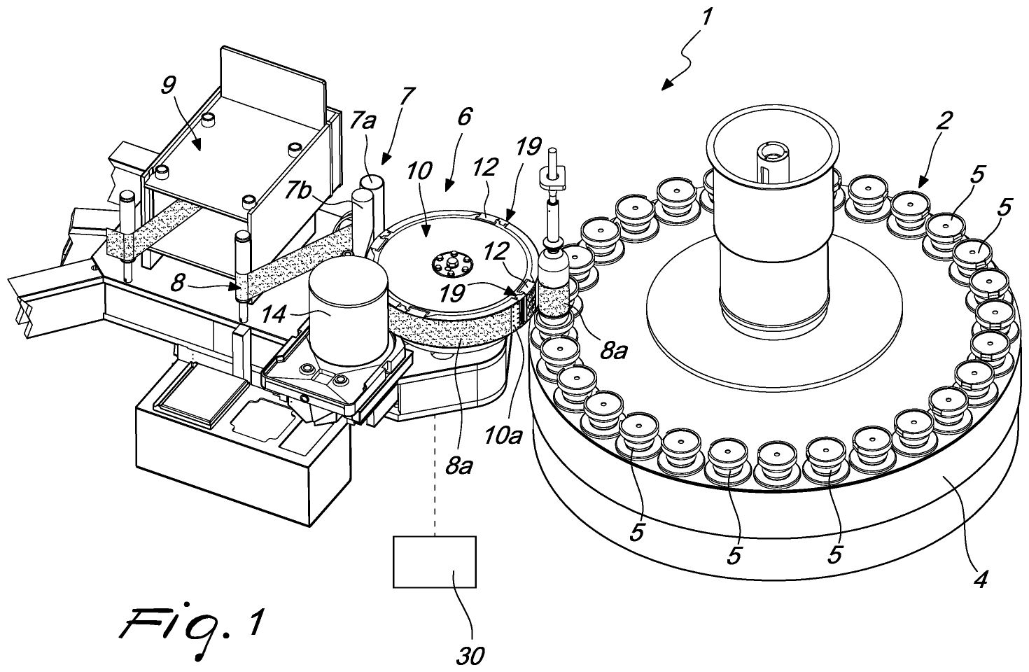

FIG. 1 is a perspective view of the labeling machine according to the invention;

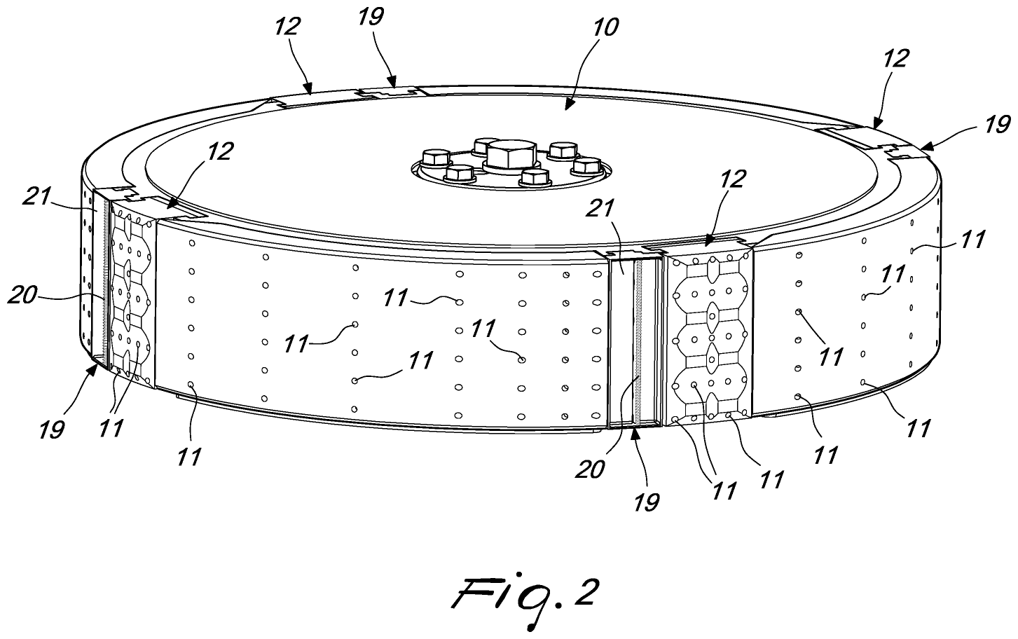

FIG. 2 is a perspective view of a cutting and transfer drum of the machine according to the invention;

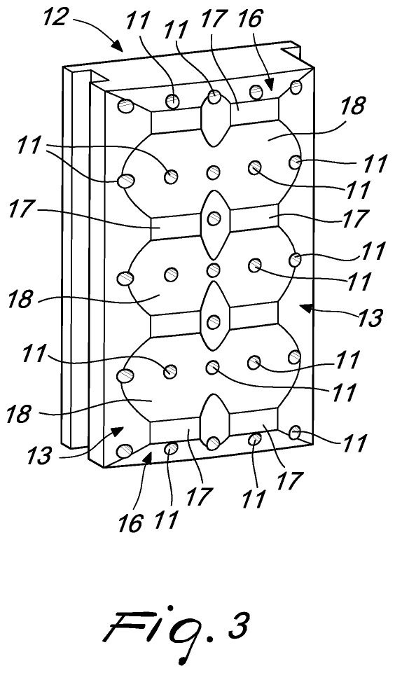

FIG. 3 is a perspective view of a runner of the drum of the machine according to the invention;

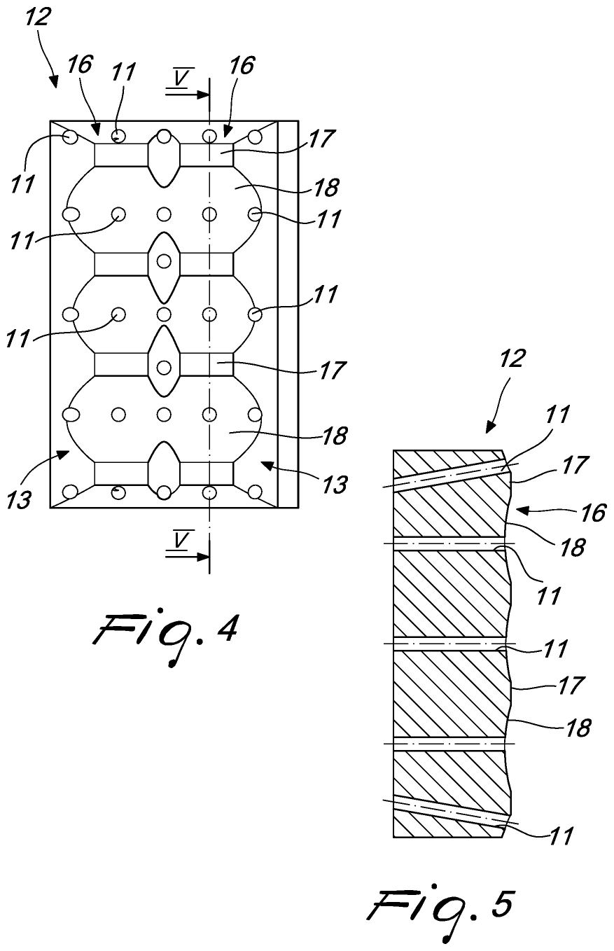

FIG. 4 is a front elevation view of the runner;

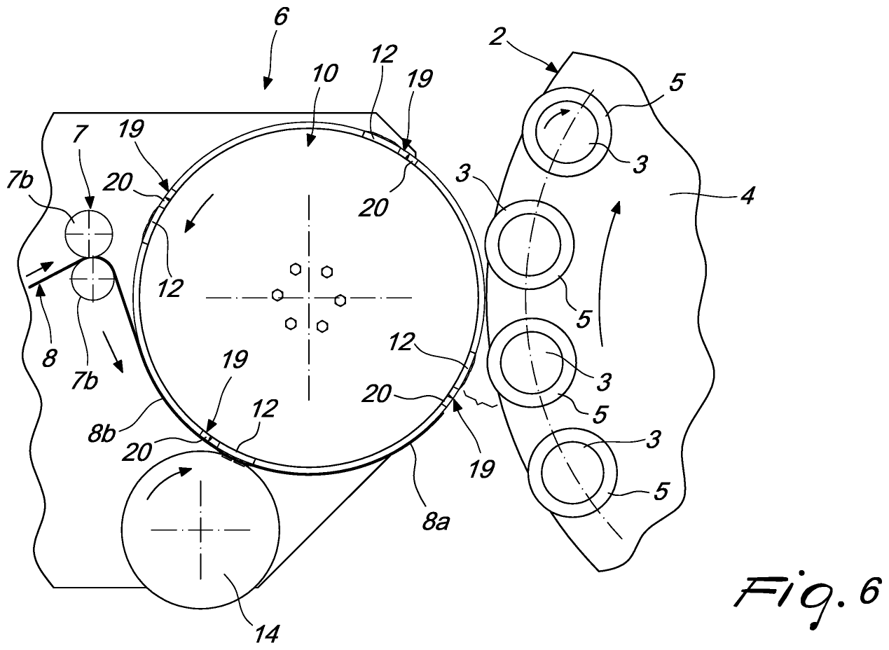

FIG. 5 is a cross-sectional view taken along the line V-V of FIG. 4;

FIGS. 6, 7 and 8 are schematic plan views from above of a sequence of steps of operation of the machine according to the invention;

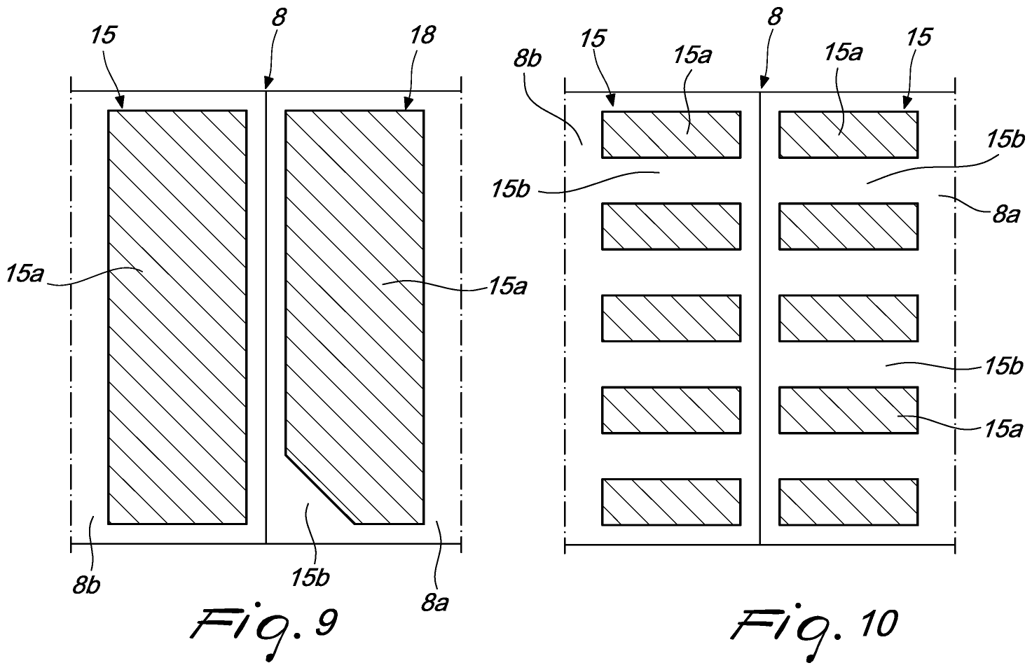

FIGS. 9, 10 and 11 show examples of adhesive imprints that can be produced by the runners on the drum of the machine according to the invention.

With reference to the figures, the labeling machine according to the invention, generally designated by the reference numeral 1, comprises a conveyor 2 of the containers 3 to be labeled along an advancement path.

The conveyor 2 is, for example, constituted by a rotating carousel 4 which has, at its peripheral region, pans 5 for supporting each individual container 3, which also rotate, so as to make the containers 3 rotate about their axes.

Along the advancement path of the containers 3, there is at least one labeling station 6, which has an unwinding assembly 7 which is constituted, for example, by a pair of counter-rotating entrainment rollers 7a, 7b, which makes it possible to take a continuous label ribbon 8, on which a plurality of labels 8a, 8b are printed in succession, from a reel (not shown).

Conveniently, the label ribbon 8 taken from the reel by the unwinding assembly 7 is also caused to pass through a device 9 for straightening and adjusting the tension of the label ribbon 8, as is known per se.

The labeling station 6 further comprises at least one drum 10, which can rotate about its own axis and is designed to receive, in adherence to the lateral surface 10a thereof, the label ribbon 8 and/or the labels 8a, 8b.

To this end, as is known per se, on the lateral surface 10a of the drum 10 there are suction holes 11, which are connected to a vacuum source (not shown) in order to enable the adhesion of the label ribbon 8 and/or of the labels 8a, 8b to the drum 10.

Peripherally, the drum 10 is further provided with runners 12, which are arranged mutually angularly spaced apart around the axis of the drum 10.

Each one of the runners 12 has at least one respective relief portion 13, in relief with respect to the lateral surface 10a of the drum 10, which can be engaged via contact by the label ribbon 8 and/or by the labels 8a, 8b.

Conveniently, in order to ensure the adherence of the label ribbon 8 and/or of the labels 8a, 8b to the runners 12, there are suction ports 11 defined at the runners 12 as well.

Laterally to the drum 10 an adhesive spreading roller 14 is arranged, which makes it possible to apply the glue to the label ribbon 8 and/or to the labels 8a, 8b.

In particular, the runners 12 define, on at least one part of the relief portion 13 thereof, at least one region for applying glue, which is designed to face the spreading roller 14, so that, when the runners 12 pass in front of the spreading roller 14, the spreading roller 14 can apply, on the leading and trailing edges of the labels 8a, 8b which are in contact with the relief portion 13 of the runners 12, at least one respective adhesive imprint 15, so as to enable the subsequent adhesion of the labels 8a, 8b to the respective containers 3.

At least one of the runners 12 has, substantially at the region for applying glue, at least one contoured part 16 with at least one abutment region 17 defined, for the spreading roller 14, which protrudes to a greater extent from the lateral surface 10a of the drum 10, with respect to at least one other region 18 of the contoured part 16 which consequently is not intended to come into contact with the spreading roller 14, so that the spreading roller 14 can transfer glue to the portions of the label ribbon 8 or of the labels 8a, 8b that are located at the abutment region 17 but not on the portions that are located, instead, at the region 18.

In this manner, it is possible for the spreading roller 14 to apply, on the portion of the label ribbon 8 and/or of the labels 8a, 8b in contact with the contoured part 16, at least one adhesive imprint 15 which has not only at least one region 15a that contains adhesive, which is achieved by virtue of the abutment region 17 of the contoured part 16, but also at least one region 15b without adhesive, in the part thereof that is provided at the region 18 of the contoured part 16 of the runner 12.

The presence of a region 15b without adhesive in the adhesive imprint 15 made by the spreading roller 14 enables a saving in the amount of adhesive that is transferred by the spreading roller 14 to the labels 8a, 8b, in addition to enabling an easier removal of the labels 8a, 8b from the containers 3, once applied, so as to facilitate the reuse of the containers 3 after their content has been consumed.

Preferably, each one of the runners 12 of the drum 10 has at least one contoured part 16.

For example, the contoured part 16 can comprise an abutment region 17, substantially continuous and, preferably, presenting a certain outward convexity, which affects substantially most of the contoured part 16 and which longitudinally extends substantially in parallel to the axis of the drum 10, and a region 18 that protrudes to a lesser extent from the lateral surface 10a of the drum with respect to the abutment region 17, which is located at the peripheral region of the contoured part 16.

With the contoured part 16 thus structured, it is, in practice, possible to deposit an adhesive imprint 15 on the labels 8a, 8b that is predominantly constituted by a single region 15a with adhesive substantially in strip form, which affects most of the transverse extension of the labels 8a, 8b, except for one region 15b without adhesive at its peripheral region, which can create a kind of missing corner or portion of the strip formed by the region 15a with adhesive, so as to make the labels 8a, 8b easily removable by tearing them off the containers 3 starting by lifting the end flap of the labels where the region 15b without adhesive of the adhesive imprint 15 is located.

Alternatively, the contoured part 16 can also comprise a plurality of abutment regions 17 which are located and mutually separated by regions 18 that protrude to a lesser extent from the lateral surface of the drum 10 with respect to the abutment regions 17, so as to be able to form adhesive imprints 15 that are formed by multiple regions 15a with adhesive which are mutually spaced apart and interleaved by regions 15b without adhesive, so as to allow the adhesion of the labels 8a, 8b only at some points of their adhesive imprints 15, in particular at those points where a greater holding force is required, but not in other regions, where it is not necessary, so as to be able to achieve a considerable saving of adhesive.

For example, if the outer surface of the containers 3 is contoured with crests and troughs, it is possible for the abutment regions 17 to be positioned so that the regions 15a with adhesive which are provided in the adhesive imprint 15 are arranged at the crests and not at the troughs present on the containers 3.

In practice, the abutment regions or region 17 are constituted by respective raised portions defined in the contoured part 16, while the regions or region 18 are constituted by respective hollows, again defined in the contoured part 16.

With reference now more specifically to the embodiment shown in the figures, it can be noted that the drum 10 is fed the label ribbon 8 directly by the unwinding assembly 7 and has, distributed along its perimeter, a plurality of cutting devices 19, which can be activated on command to perform the cutting of the label ribbon 8 between one label 8a, 8b and the next.

Conveniently, such cutting devices 19 are adapted to perform the cutting of the label ribbon 8 at the separation portion between two consecutive labels 8a, 8b, along the label ribbon 8, after the application, by the spreading roller 14, of two adhesive imprints 15, one on the trailing edge of one of these two consecutive labels, corresponding, for example, to the edge indicated in FIGS. 6, 7 and 8 with 8a, and the other one on the leading edge of the other label 8b, immediately after the previous label, in the advancement direction of the label ribbon 8.

In this case, each one of the runners 12 comprises at least two relief portions 13, which are designed, in each instance, to receive in contact therewith, respectively, the trailing edge and the leading edge of two consecutive labels 8a, 8b of the label ribbon 8.

In particular, both of the relief portions 13 on each runner 12 define a respective region for applying glue, and at least one of these comprises at least one contoured region 16.

More specifically, the relief portion 13 that comprises at least one contoured region 16 is at least the portion that is intended to receive in contact therewith the trailing edge of a label 8a, 8b, so that if the labels 8a, 8b are applied on containers 3 with the trailing edge overlapping the leading edge of the labels 8a, 8b, the facilitated removal of those labels is made possible by virtue of the presence, on the trailing edge of the labels, of an adhesive imprint 15 with at least one region 15b without adhesive, which allows the removal thereof by pulling.

It is also possible, as an alternative, for each one of the relief portions 13 on each runner 12 to comprise at least one respective contoured part 16.

Examples of adhesive imprints 15 that can be provided using two relief portions 13 of the runners 12 are shown in FIGS. 9, 10 and 11.

In particular, FIG. 9 shows a pair of adhesive imprints 15 that can be provided on the label ribbon 8, respectively at the trailing edge of a label 8a and at the leading edge of a label 8b consecutive to the label 8a, by a runner 12 that has a first relief portion 13 having a contoured part 16 that can provide, on the trailing edge of the label 8a, an adhesive imprint 15 that has a region 15a with adhesive in a strip transverse to the label 8a, which is missing, at a region 15b without adhesive, a corner on its side facing toward the label 8b, and a second relief portion 13, structured according to the known art and capable, therefore, of providing, on the leading edge of the label 8b, an adhesive imprint 15 that essentially is fully constituted by a region 15a with adhesive, in a rectangular strip transverse to the label 8b, which extends almost along the entire transverse extension of the label 8b.

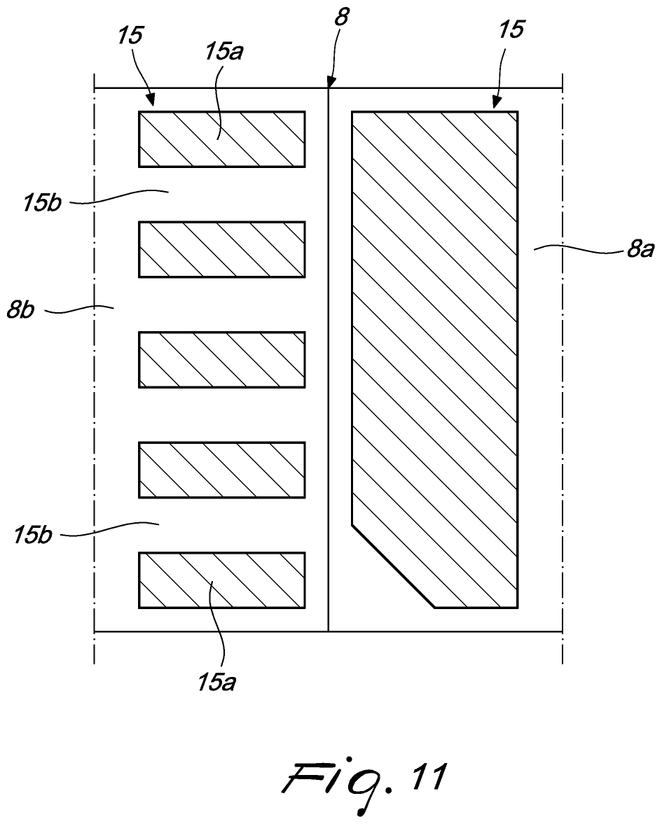

Differently, FIG. 10 shows a pair of adhesive imprints 15 that can be provided on the label ribbon 8 by a runner 12 that has two relief portions 13, both of which have, in turn, a respective contoured part 16 capable of forming, at the leading edge and at the trailing edge of two consecutive labels 8a, 8b, following the passage of the latter in front of the spreading roller 14, adhesive imprints 15 that comprise multiple localized regions 15a with adhesive, each one having a substantially rectangular shape that extends substantially in parallel to the extension of the label ribbon 8, and which are interleaved, in a direction transverse to the labels 8a, 8b, by regions 15b without adhesive.

FIG. 11 shows adhesive imprints 15 provided on the label ribbon 8, at the trailing edge and at the leading edge of two consecutive labels 8a and 8b, by a runner 12 both relief portions 13 of which are provided with a respective contoured part 16, with the adhesive imprint 15 provided at the trailing edge of the label 8a constituted by a continuous region 15a with adhesive in a strip transverse to the label 8a but lacking a corner constituted by a region 15b without adhesive, and with the adhesive imprint 15, provided at the leading edge of the label 8b, constituted by multiple localized regions 15a with adhesive which are mutually separated, transversely with respect to the label 8b, by regions 15b without adhesive.

Again with reference to the embodiment illustrated in the figures, each one of the runners 12 of the drum 10 is associated with a respective cutting device 19 which is arranged in a position immediately behind the corresponding runner 12, in the direction of rotation of the drum 10.

Conveniently, in this case control means are provided for controlling the machine, constituted for example by an electronic control unit 30, which are adapted to drive the unwinding assembly 7 for unwinding the label ribbon 8 in order to vary the feeding speed of the label ribbon 8 to the drum 10, by the unwinding assembly 7, with respect to the peripheral speed of the drum itself, so as to have steps of operation of the machine in which the peripheral speed of the drum 10 is faster than the speed with which the label ribbon 8 is fed to the drum 10 by the unwinding assembly 7, so as to obtain a slippage of the lateral surface of the drum 10 on the label ribbon 8, and steps of operation of the machine in which, differently, the feeding speed of the label ribbon 8 to the drum 10 is substantially the same as the peripheral speed of the drum 10.

In particular, the control means can command a slowing of the feeding speed of the label ribbon 8 to the drum 10 by the unwinding assembly 7, immediately after the passing, in front of the spreading roller 14, of a runner 12 with the trailing edge and the leading edge of two consecutive labels 8a, 8b of the label ribbon 8 in contact therewith, with application, by the spreading roller 14, of two adhesive imprints 15, respectively one on the trailing edge and the other on the leading edge of the above mentioned two consecutive labels 8a, 8b which are in contact with the runner 12.

In this manner, the consequent slippage of the drum 10 on the label ribbon 8 makes it possible to cause a stretching of the label ribbon 8, so as to avoid the situation where, following its adhesion to the contoured parts 16 of the runner 12, the label ribbon 8 might remain wrinkled, and this slippage further makes it possible to bring the cutting device 19 directly behind the runner 12 on which the spreading roller 14 has applied the adhesive imprints 15, at the separation portion between the two consecutive labels 8a, 8b that have received the adhesive imprints 15, in order to then allow the execution of the cutting of the label ribbon 8 and the separation therefrom of the label 8a preceding the other label 8b in the direction of advancement of the label ribbon 8.

The label 8a, once separated from the label ribbon 8, following the cut, is kept so that it adheres to the lateral surface 10a of the drum 10 by virtue of the suction holes 11, so that the drum 10 can bring it to adhere to the corresponding container 3 arriving on the carousel 4.

It should be noted that at the moment of the cutting of the label ribbon 8 by the corresponding cutting device 19, the control means command the unwinding assembly 7 to feed the label ribbon 8 to the drum 10 at a speed that is substantially the same as the peripheral speed of the drum 10, so that the cutting of the label ribbon 8 can take place in a condition of substantial synchronization between the movement of the label ribbon 8 and the movement of the cutting device 19.

After performing the cutting of the label ribbon 8, it is also possible for the control means to command a slowing of the feeding speed of the label ribbon 8 to the drum 10, with respect to the peripheral speed of the drum 10, so that the drum 10, by dragging on the label ribbon 8, can pull the label 8a obtained after cutting away from the rest of the label ribbon 8.

Advantageously, in the embodiment illustrated, each cutting device 19 comprises a respective blade 20, arranged inside a cutting chamber 21, which is open onto the lateral surface 10a of the drum 10 and can be connected to suction means, for example constituted by the same vacuum source that is connected to the suction holes 11 of the drum 10, so as to be able to attract the portion of label ribbon 8 that faces the cutting device 19, inward into the corresponding cutting chamber 21, thus bringing it against the blade 20, so as to perform the cutting thereof.

Operation of the labeling machine, according to the invention, is the following.

Starting from the situation shown in FIG. 6, the unwinding assembly 7 feeds the label ribbon 8 to the drum 10 at a speed that corresponds substantially to the peripheral speed of the drum 10, while a runner 12, with the relief portions 13 of which the trailing edge and the leading edge of two consecutive labels 8a, 8b of the label ribbon 8 are respectively in contact, passes in front of the spreading roller 14, in such a way that the spreading roller 14 can apply, on the portion of label ribbon 8 in contact therewith, two adhesive imprints 15, of which one is at the trailing edge of the label 8a, which precedes the label 8b in the direction of advancement of the label ribbon 8, and the other is at the leading edge of the label 8b.

In this situation, the suction holes 11 present on the runner 12 are, conveniently, activated by way of their connection to the vacuum source, so that the label ribbon 8 is caused to adhere perfectly to the relief portions 13 of the runner 12 so as to assume their shape by virtue of the action of attraction toward the relief portions 13 exerted by the suction holes 11 present in the runner 12.

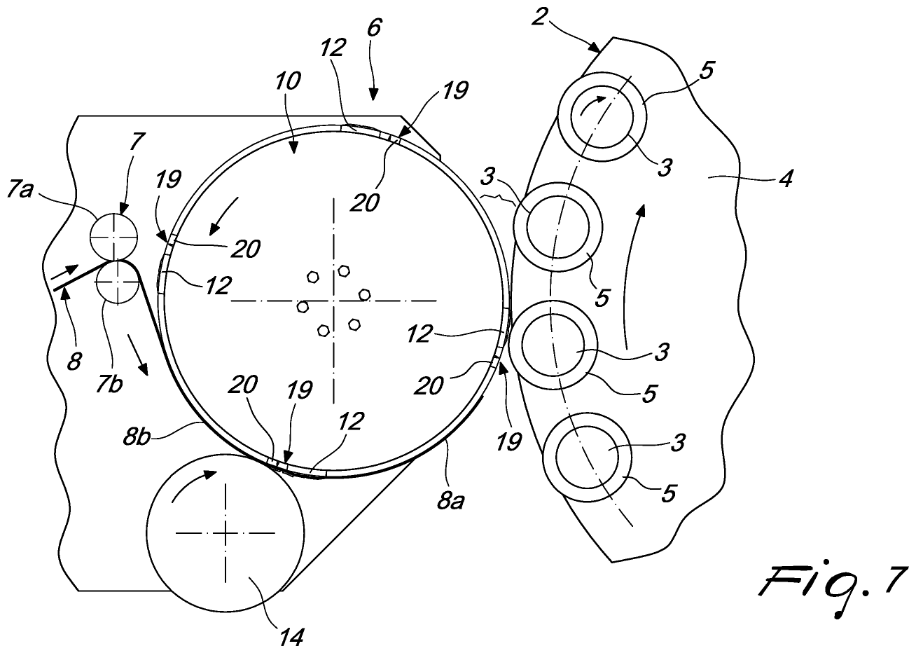

Once the adhesive imprints 15 have been applied on the trailing edge and on the leading edge of the labels 8a, 8b, we arrive at the situation of FIG. 7, in which the unwinding assembly 7 for unwinding the label ribbon 8 is actuated, following a command of the control means, so as to feed the label ribbon 8 to the drum 10 at a slower speed than the peripheral speed of the drum 10.

In this manner, the drum 10 can slip against the label ribbon 8, so as to stretch the label ribbon 8 and make the label ribbon 8 resume the original shape after adhering to the runner 12, thus avoiding the situation where it might remain wrinkled following its adherence to the contoured parts or part 16 of the runner 12, and, furthermore, in order to bring, to the separation portion between the two labels 8a, 8b on which the adhesive imprints 15 have been applied, the cutting device 19 immediately behind (in the direction of rotation of the drum 10) the runner 12 that in the previous step was in front of the spreading roller 14.

It should be noted that, during this slippage of the drum 10 on the label ribbon 8, at least one part of the suction holes 11 present on the runner 12 are, conveniently, deactivated, by cutting their connection to the vacuum source, thus helping to prevent wrinkling in the label ribbon 8 from remaining.

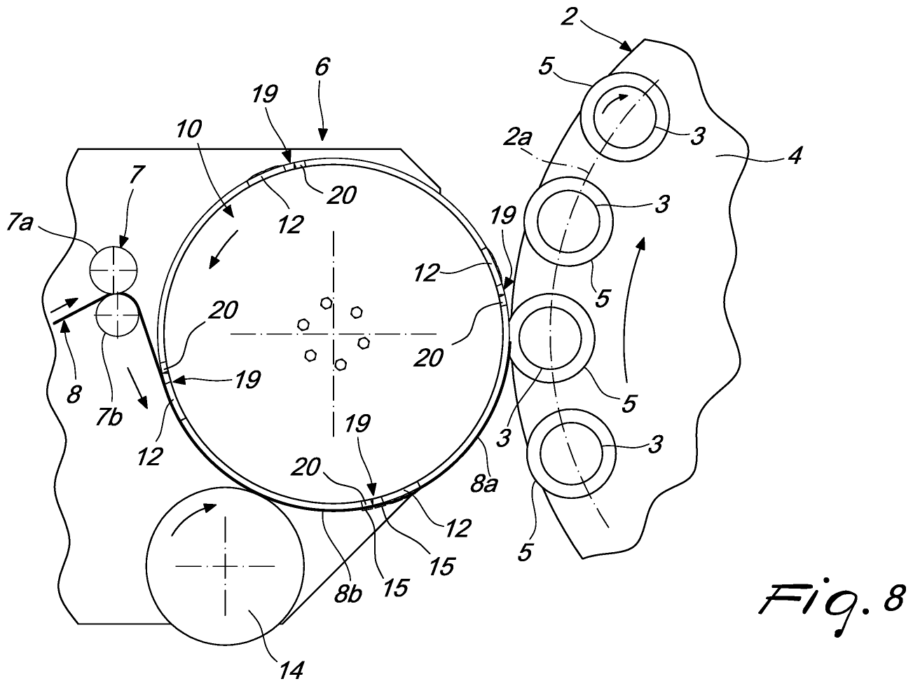

FIG. 8 shows the situation where the cutting device 19 immediately behind the runner 12 with which the leading and trailing edges of the labels 8a, 8b that received the adhesive imprints 15 were in contact, has arrived, with the corresponding blade 20, at the separation portion between the labels 8a, 8b.

In this situation, the label ribbon 8 is fed again by the unwinding assembly 7 at a speed that substantially corresponds to the peripheral speed of the drum 10, and the cutting chamber 21 of the cutting device 19, which is at the separation region between the labels 8a, 8b, is connected to the suction means, so as to attract the label ribbon 8 inward into the cutting chamber 21, pushing it against the corresponding blade 20, so as to obtain the cutting of the label ribbon 8, with separation of the label 8a therefrom.

After the cutting of the label 8a, the control means command another slowing down, by the unwinding assembly 7, of the feeding speed of the label ribbon 8 to the drum 10, with respect to the peripheral speed of the drum 10, so as to bring away the label 8a that was cut from the rest of the label ribbon 8 and position the next runner 12, in the direction of rotation of the drum 10, after the runner on which the label 8a has received the adhesive, at the separation portion between the label 8b and the label immediately following it along the label ribbon 8, in order to then return the feeding speed of the label ribbon 8 to a value that substantially corresponds to the peripheral speed of the drum 10, so as to be able to resume the operating cycle, while the label 8a cut from the label ribbon 8 will be delivered by the drum 10 to the respective container 3 conveyed by the conveyor 2.

In practice it has been found that the invention fully achieves the intended aim and objects by providing a labeling machine that makes it possible to achieve, with respect to the known art, a valid optimization of the use and of the consumption of the glue that is applied on the labels, with a very simple structure and without compromising the quality of the labeling.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102021000004100 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-7. (canceled)

8. A labeling machine comprising a conveyor for conveying containers to be labeled along an advancement path and at least one labeling station arranged along said advancement path and provided with an unwinding assembly for unwinding a continuous label ribbon on which a plurality of labels are printed in succession, and at least one drum which is designed to receive, in adherence to a lateral surface thereof, said label ribbon and/or said labels and is provided, peripherally, with runners which have at least one relief portion, in relief with respect to the lateral surface of the drum, which is configured to be engaged via contact by said label ribbon and/or said labels, a spreading roller for spreading adhesive on said label ribbon and/or said labels being arranged laterally to said drum in order to apply at least one respective adhesive imprint to leading and trailing edges of said labels, which are in contact with said at least one relief portion of said runners, wherein at least one of said runners has at least one contoured part with at least one abutment region defined for said spreading roller and protruding to a greater extent from the lateral surface of said drum with respect to at least one other region of said at least one contoured part, in order to allow application, by said spreading roller, on the portion of said label ribbon and/or of said labels that is in contact with said at least one contoured part, of at least one adhesive imprint which has at least one region without adhesive.

9. The machine according to claim 8, wherein each one of said runners has at least one contoured part.

10. The machine according to claim 9, wherein said at least one contoured part comprises a substantially continuous abutment region and a region protruding to a lesser extent from the lateral surface of said drum with respect to said abutment region, located in a peripheral region of said at least one contoured part.

11. The machine according to claim 9, wherein said at least one contoured part comprises a plurality of abutment regions which are located and mutually separated by regions that protrude to a lesser extent from the lateral surface of said drum with respect to said abutment regions.

12. The machine according to claim 8, wherein each one of said runners comprises at least two relief portions, which are designed to receive in contact therewith, respectively, the trailing edge and the leading edge of two consecutive labels of said label ribbon, at least one of said relief portions comprising at least one said contoured part.

13. The machine according to claim 12, wherein the relief portion that comprises at least one said contoured part corresponds to the one designed to receive in contact therewith the trailing edge of a label.

14. The machine according to claim 8, wherein each one of said at least two relief portions comprises at least one said contoured part.
